(19) United States
(12) Patent Application Publication
(10) Pub. No.: US 2026/0158866 A1
(43) Pub. Date: Jun. 11, 2026

(54) HEAT PUMP SYSTEM FOR VEHICLE

(71) Applicant: Hanon Systems, Daejeon (KR)

(72) Inventors: Sang Gu WOO, Daejeon (KR); Jae Chun RYU, Daejeon (KR); Yu Ho LEE, Daejeon (KR)

(73) Assignee: Hanon Systems, Daejeon (KR)

(21) Appl. No.: 19/125,689

(22) PCT Filed: Feb. 20, 2024
(86) PCT No.: PCT/KR2024/095422

§ 371 Date: Apr. 29, 2025

(30) Foreign Application Priority Data
May 2, 2023 (KR) 10-2023-0057317

(51) Int. Cl. B60H 1/14; B60H 1/00; B60H 1/32; F25B 30/02

(52) U.S. Cl. CPC B60H 1/143; B60H 1/00278; B60H 1/00485; B60H 1/00899; B60H 1/3227; F25B 30/02

(57) ABSTRACT

Disclosed is a heat pump system for a vehicle that includes: a compressor which compresses and discharges a refrigerant; an indoor heat exchanger which is provided in an air-conditioning case and exchanges heat with air discharged into the indoor space of the vehicle; an outdoor heat exchanger which is provided on the outer portion of the air-conditioning case and exchanges heat with external air; and a first expansion valve which expands the refrigerant, and the heat pump system carries out heating and cooling of the indoor space of the vehicle through the indoor heat exchanger while controlling the flow of the refrigerant discharged from the compressor, wherein the indoor heat exchanger is divided into a plurality of columns on an air passage in the air-conditioning case and includes a refrigerant direction switching portion which controls the flow of the refrigerant.

### TECHNICAL FIELD

The present invention relates to a heat pump system for a vehicle, and more specifically, to a heat pump system for a vehicle, which can delete a temperature door and realize cooling and heating according to modes through an indoor heat exchanger.

### BACKGROUND ART

In general, an air conditioner for a vehicle includes a cooling system for cooling the indoor space of the vehicle, and a heating system for heating the indoor space of the vehicle. The cooling system, at an indoor heat exchanger side of a refrigerant cycle, converts the air passing the outside of the indoor heat exchanger into cold air by exchanging heat between the air and a refrigerant flowing inside an evaporator to cool the indoor space of the vehicle. Moreover, the heating system, at a heater core side of a cooling water cycle, converts the air passing the outside of the heater core into warm air by exchanging heat between the air and cooling water flowing inside the heater core to heat the indoor space of the vehicle.

Meanwhile, a heat pump system capable of selectively performing cooling and heating by changing the flow direction of a refrigerant using one refrigerant cycle, which is different from the above-described air conditioner for the vehicle, is applied.

The heat pump system includes an indoor heat exchanger installed inside an air-conditioning case to exchange heat with air blown into the indoor space of the vehicle, an outdoor heat exchanger for exchanging heat outside the air-conditioning case, and a direction switching valve capable of switching a flow direction of the refrigerant. When a cooling mode is activated according to the flow direction of the refrigerant by the direction switching valve, the indoor heat exchanger performs the function of a cooling heat exchanger, and when the heating mode is activated, the indoor heat exchanger performs the function of a heating heat exchanger.

Referring to FIG. 1, a conventional heat pump system for a vehicle includes an indoor heat exchanger 15, an auxiliary heat exchanger 11, an outdoor heat exchanger 10, a four-way valve 20, and a three-way valve 30.

The indoor heat exchanger 15 is arranged inside a case 16 in the indoor space of the vehicle and exchanges heat with the air supplied into the indoor space. The indoor heat exchanger 15 selectively converts the functions of a condenser and an evaporator according to operation modes. Inside the case 16, the auxiliary heat exchanger 11 is provided downstream of the indoor heat exchanger 15 in the air flow direction.

The auxiliary heat exchanger 11 operates as the evaporator when the indoor heat exchanger 15 is operated as the condenser, but operates as the condenser when the indoor heat exchanger 15 is operated as the evaporator. The outdoor heat exchanger 10 exchanges heat with external air, and the refrigerant that has passed through the indoor heat exchanger 15 passes through a four-way valve 20 which is selectively controlled to perform a reverse cycle circulation. The three-way valve 30 is provided such that the refrigerant passing through the four-way valve 20 is selectively branched into the auxiliary heat-exchanger 11.

The heat pump system for the vehicle includes a first line 1, a second line 2, and a third line 3. The refrigerant passing through the four-way valve 20 through the first line 1 is always recirculated to the four-way valve 20. The first line 1 includes an accumulator 32 for separating gas and liquid from a refrigerant and a compressor 33. The three-way valve 30 is installed on the first line 1, and the second line 2 is connected to the three-way valve 30.

The refrigerant passing through the three-way valve 30 is selectively divided into the auxiliary heat exchanger 11. The third line 3 allows the refrigerant passing through the auxiliary heat exchanger 11 to be supplied to the accumulator 32. The third line 3 includes a connector 31 so that the refrigerant passing through the auxiliary heat-exchanger 11 can be connected to the accumulator 32. Between the indoor heat exchanger 15 and the outdoor heat exchanger 10, an expansion valve 12 performing a throttling action is provided.

In a cooling mode, the refrigerant discharged from the compressor 33 passes through the four-way valve 20, is condensed while passing through the outdoor heat-exchanger 10, expands while passing through the expansion valve 12, and then is evaporated while passing through the indoor heat exchanger 15. Thereafter, the refrigerant passes through the four-way valve 20, passes through the three-way valve 30, passes through the auxiliary heat exchanger 11, and then, circulates through the compressor 33.

In a heating mode, the refrigerant discharged from the compressor 33 passes through the four-way valve 20, is condensed while passing through the indoor heat-exchanger 15, expands while passing through the expansion valve 12, and then is evaporated while passing through the outdoor heat exchanger 10. Thereafter, the refrigerant passes through the four-way valve 20, passes through the three-way valve 30, and then, circulates the compressor 33. In this case, the refrigerant passing through the three-way valve 30 bypasses the auxiliary heat exchanger 11.

In a dehumidification mode, the refrigerant discharged from the compressor 33 passes through the four-way valve 20, is condensed while passing through the indoor heat exchanger 15, expands while passing through the expansion valve 12, and then, is evaporated while passing through the outdoor heat exchanger 10. Thereafter, the refrigerant passes through the four-way valve 20, passes through the three-way valve 30, is evaporated while passing through the auxiliary heat exchanger 11, and then, circulates through the compressor 33.

In the conventional heat pump system for a vehicle, the indoor heat exchanger 15 and the auxiliary heat exchanger 11 must be arranged inside the case 16. So, the weight and the package size increase to the equivalent level to those of the air conditioner in which an evaporator and a heater core are installed. In addition, in the heating mode, the auxiliary heat exchanger is not used, so occupies only a space and cannot improve air-conditioning performance.

Furthermore, the conventional heat pump system for a vehicle does not use the auxiliary heat exchanger 11 in the heating mode. Additionally, the conventional heat pump system for a vehicle requires an inflow pipe and a discharge pipe for the indoor heat exchanger and an inflow pipe and a discharge pipe for the auxiliary heat exchanger. As a result, the conventional heat pump system for a vehicle requires a total of four pipes connecting the engine room and the indoor space of the vehicle. Meanwhile, in a heating dehumidification mode, the indoor heat exchanger 15 and the auxiliary heat exchanger 11 are used.

### DISCLOSURE

### Technical Problem

Accordingly, the present invention has been made in view of the above-mentioned problems occurring in the related art, and it is an objective of the present invention to provide a heat pump system for a vehicle, which is capable of realizing all of cooling, heating, and dehumidification functions with a heat exchanger having a size of an evaporator, from which a temperature door and an actuator for temperature control can be deleted, and which requires only two pipes connecting an engine room and an indoor space of the vehicle.

In addition, it is another objective of the present invention to provide a heat pump system for a vehicle, in which an indoor heat exchanger is provided as a two-column integration type and the arrangement of a four-way valve is optimized so that a refrigerant can always initially flow into a second column regardless of air-conditioning modes.

### Technical Solution

To accomplish the above-mentioned objects, according to the present invention, there is provided a heat pump system for a vehicle including: a compressor which compresses and discharges a refrigerant; an indoor heat exchanger which is provided in an air-conditioning case and exchanges heat with air discharged into the indoor space of the vehicle; an outdoor heat exchanger which is provided on an outer portion of the air-conditioning case and exchanges heat with external air; and a first expansion valve which expands the refrigerant; and controls the flow of the refrigerant discharged from the compressor to perform heating and cooling of the indoor space of the vehicle through the indoor heat exchanger, wherein the indoor heat exchanger is divided into a plurality of columns on an air passage in the air-conditioning case, and a refrigerant direction switching portion which controls the flow of the refrigerant is provided such that the refrigerant can first flow into the last column, among the plurality of columns, regardless of air-conditioning modes.

The refrigerant direction switching portion comprises: a first direction switching valve which is provided downstream of the compressor in a refrigerant flow direction to selectively flow the refrigerant to the outdoor heat exchanger or the indoor heat exchanger; and a second direction switching valve which is provided upstream of the indoor heat exchanger in the refrigerant flow direction to send the refrigerant which has passed through the compressor to the indoor heat exchanger or to send the refrigerant which has passed through the first expansion valve to the indoor heat exchanger.

The first direction switching valve and the second direction switching valve are configured as four-way valves.

The indoor heat exchanger is an integrated heat exchanger divided into a plurality of columns.

A second expansion valve which selectively expands the refrigerant is provided in the refrigerant line between the plurality of indoor heat exchangers.

The indoor heat exchanger includes a first indoor heat exchanger and a second indoor heat exchanger sequentially arranged in an air flow direction, and the first indoor heat exchanger and the second indoor heat exchanger are connected in series on a refrigerant line.

A refrigerant branch line is provided between the outdoor heat exchanger and the second direction switching valve such that the refrigerant passing through the outdoor heat exchanger selectively bypasses the indoor heat exchanger to direct to the compressor or the refrigerant passing through the indoor heat exchanger selectively bypasses the outdoor heat exchanger to direct to the compressor.

In the refrigerant branch line, a third expansion valve for selectively expanding the refrigerant and a chiller for exchanging heat the refrigerant with coolant circulating through electrical components or a battery of the vehicle are provided.

A fourth expansion valve for selectively expanding the refrigerant is provided between the outdoor heat exchanger and the refrigerant branch line.

The first direction switching valve connects the upstream side of the compressor, the downstream side of the compressor, the second direction switching valve, and the outdoor heat exchanger, and the second direction switching valve connects the first indoor heat exchanger, the second indoor heat exchanger, the first direction switching valve, and the first expansion valve.

In a cooling mode, the refrigerant discharged from the compressor passes through the first direction switching valve and the outdoor heat exchanger, expands in the first expansion valve after passing through the fourth expansion valve, passes through the second direction switching valve, passes through the second indoor heat exchanger, passes through the second expansion valve, passes through the first indoor heat exchanger, passes through the second direction switching valve and the first direction switching valve, and then, circulates to the compressor.

In the cooling mode, some of the refrigerant passing through the fourth expansion valve flows to the refrigerant branch line, expands in the third expansion valve, and then passes through the chiller, circulates to the compressor.

In the heating mode, the refrigerant discharged from the compressor passes through the first direction switching valve and the second direction switching valve, passes through the second indoor heat exchanger, passes through the second expansion valve, passes through the first indoor heat exchanger, expands in the first expansion valve after passing through the second direction switching valve, flows to the refrigerant branch line, passes through the third expansion valve, passes through the chiller, and then circulates to the compressor.

In the heating mode, some of the refrigerant passing through the first expansion valve passes through the fourth expansion valve, passes through the outdoor heat exchanger and the first direction switching valve, and then circulates to the compressor.

In a dehumidification mode, the refrigerant discharged from the compressor passes through the first direction switching valve and the second direction switching valve, expands in the second expansion valve after passing through the second indoor heat exchanger, passes through the first indoor heat exchanger, passes through the second direction switching valve, passes through the first expansion valve, and then circulates to the compressor after passing through the chiller or the outdoor heat exchanger.

### Advantageous Effect

The heat pump system for a vehicle according to the present invention is configured so that the refrigerant always flows to the second indoor heat exchanger earlier than the first indoor heat exchanger in all air-conditioning modes, thereby improving both the cooling performance and the heating performance. Therefore, the heat pump system for a vehicle according to the present invention may improve heat-exchange efficiency by allowing a colder refrigerant in the cooling mode or a hotter refrigerant in the heating mode to pass through the second indoor heat exchanger located downstream in the air flow direction.

Moreover, the heat pump system for a vehicle according to an embodiment of the present invention includes one indoor heat exchanger divided into two parts, thereby realizing all functions of cooling, heating, and dehumidifying with the heat exchanger having the size of the conventional evaporator. Additionally, since it is possible to delete the conventional temperature adjustment door and actuator for adjusting the temperature, the heat pump system for a vehicle according to an embodiment of the present invention can simplify the component configuration and reduce the weight and cost.

Additionally, the heat pump system for a vehicle may include the indoor heat exchanger with first and second columns, wherein the first and second columns can be divided and an EXV type electronic expansion valve is provided between the first and second columns, thus maximizing utilization of the indoor heat exchanger in all air-conditioning-modes such as a cooling mode, a heating mode, a dehumidification mode, and the like.

In addition, since there is only one heat exchanger in which the refrigerant flows in the air-conditioning case by configuring one indoor heat exchanger with first and second columns, the heat pump system for a vehicle requires only two pipes connected to the heat exchanger and the engine room mounted on the air conditioner, thereby simplifying the pipeline.

### DESCRIPTION OF DRAWINGS

FIG. 1 illustrates a conventional heat pump system for a vehicle.

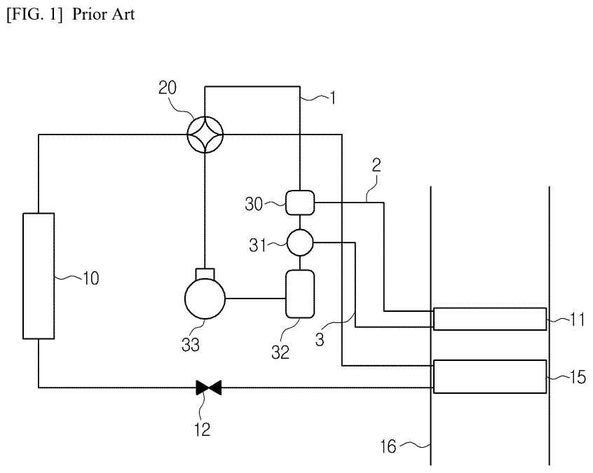

FIG. 2 illustrates a heat pump system for a vehicle according to an embodiment of the present invention.

FIG. 3 is an enlarged view of the inside of an air-conditioning case of FIG. 2.

FIG. 4 is a view illustrating a cooling mode of the heat pump system for a vehicle according to an embodiment of the present invention.

FIG. 5 is a view illustrating a heating mode of the heat pump system for a vehicle according to an embodiment of the present invention.

FIG. 6 illustrates a dehumidification mode of the heat pump system for a vehicle according to an embodiment of the present invention.

### MODE FOR INVENTION

Hereinafter, a technical configuration of a heat pump system for a vehicle will be described in detail with reference to the accompanying drawings.

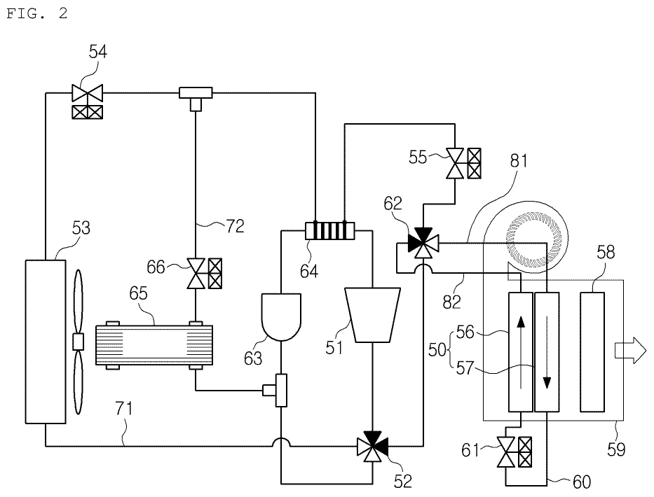

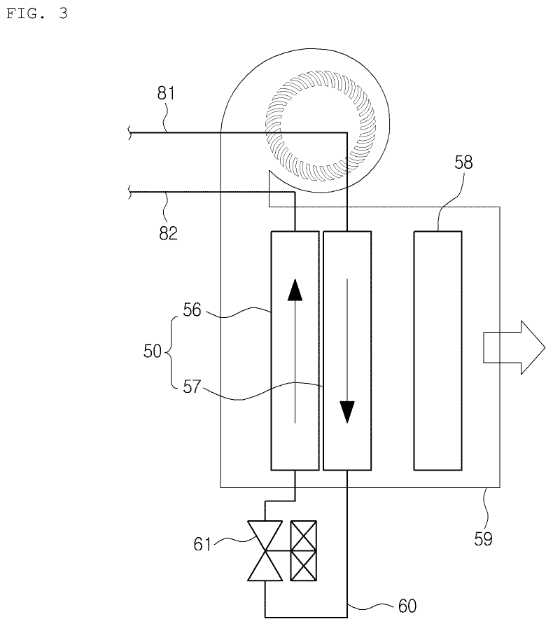

Referring to FIGS. 2 and 3, the heat pump system for a vehicle according to an embodiment of the present invention includes a compressor 51 connected to a refrigerant line 71, an indoor heat exchanger 50, an outdoor heat exchanger 53, a first expansion valve 55, a second expansion valve 61, a refrigerant direction switching portion, a third expansion valve 66, and a fourth expansion valve 54.

A blower is provided at one side of the air-conditioning case 59 to suck internal air or external air and discharge the air to the indoor space of the vehicle, and the indoor heat exchanger 50 is provided in an air passage of the air-conditioning case 59. Within the air-conditioning case 59, there is no temperature adjustment door for adjusting the temperature of the air being discharged into the indoor space. The temperature adjustment function of the discharged air is achieved through only the indoor heat exchanger 50.

An electric heater 58 such as a PTC which generates heat in accordance with the application of power may be provided downstream of the indoor heat exchanger 50 in the air flow direction. The electric heater 58 serves as an auxiliary heat source and, in a heating mode, assists the indoor heat exchanger 50 to additionally heat the air. The electric heater 58 may be a dual PTC which can be individually actuated in air passages partitioned into the left and right sides of the air-conditioning case 59.

The compressor 51 sucks and compresses a refrigerant, and then discharges the compressed refrigerant in a gaseous state of high-temperature and high-pressure. The indoor heat exchanger 50 is provided inside the air-conditioning case 59 to exchange heat with the air being discharged into the indoor space of the vehicle. The indoor heat exchanger 50 functions as a cooling heat exchanger for cooling air or a heating heat exchanger for heating air.

Furthermore, the outdoor heat exchanger 53 is provided outside the air-conditioning case 59 to exchange heat with external air, and may be installed in the front region of the vehicle. The first expansion valve 55 selectively expands the refrigerant and includes an electric expansion valve (EXV).

The heat pump system for a vehicle according to an embodiment of the present invention controls the flow of the refrigerant discharged from the compressor 51 to perform cooling and heating in the indoor space of the vehicle through the indoor heat exchanger 50. In this case, the indoor heat exchanger 50 is divided into a plurality of columns on the air passage inside the air-conditioning case 59. In addition, the second expansion valve 61 is provided in the refrigerant line 60 between the plurality of indoor heat exchangers 56 and 57.

The indoor heat exchanger 50 includes a first indoor heat exchanger 56 and a second indoor heat exchanger 57, wherein the first indoor heat exchanger 56 and the second indoor heat exchanger 57 are sequentially arranged within the air-conditioning case 59 in the air flow direction. The indoor heat exchanger 50 is configured as an integrated heat exchanger divided into a plurality of columns. The air in the air-conditioning case 59 blown through the blower sequentially passes through the first indoor heat exchanger 56, the second indoor heat exchanger 57, and the electric heater 58 and then is discharged into the indoor space of the vehicle.

The second expansion valve 61 is the electric expansion valve (EXV) to expand the refrigerant to a low-temperature and low-pressure state. The second expansion valve 61 is configured to selectively perform a function of expanding the refrigerant or a function of allowing the refrigerant to bypass. The second expansion valve 61 is separately attached to the indoor heat exchanger 50 or integrated into the indoor heat exchanger 50. The first indoor heat exchanger 56 and the second indoor heat exchanger 57 are connected in series on the refrigerant line 60.

The refrigerant direction switching portion controls the flow of the refrigerant so that the refrigerant can first flow into the last column among the plurality of columns regardless of the air conditioning modes. That is, the refrigerant direction switching portion controls the flow of the refrigerant so that the refrigerant can be always first introduced into the second indoor heat exchanger 57 regardless of the air conditioning modes. Thus, the refrigerant that has passed through the second indoor heat exchanger 57 bypasses the second expansion valve 61 or is expanded by the second expansion valve 61 and then passes through the first indoor heat exchanger 56.

Substantially, the first indoor heat exchanger 56 and the second indoor heat exchanger 57 are configured as an integrated heat exchanger, and are configured in such a way that one indoor heat exchanger 50 is bisected to perform control of the refrigerant through the second expansion valve 61 in the middle. The size of the indoor heat exchanger 50 including the first indoor heat exchanger 56 and the second indoor heat exchanger 57 is about the size of the conventional evaporator core. As a result, the indoor heat exchanger 50 has a similar size as the package from which the heater core is deleted, based on the conventional evaporator and heater core.

The engine room and the indoor space of the vehicle are partitioned based on a dash panel, and the air-conditioning case 59 is installed in the indoor space of the vehicle based on the dash panel. In this case, a total of two pipes connecting the engine room and the inside of the air-conditioning case 59 are provided. The pipe connecting the engine room and the inside of the air-conditioning case 59 includes a first pipe 81 connected to one of a plurality of indoor heat exchangers and a second pipe 82 connected to the other of the indoor heat exchangers.

That is, the first pipe 81 is connected to the second indoor heat exchanger 57, and the second pipe 82 is connected to the first indoor heat exchanger 56. The first pipe 81 and the second pipe 82 are installed to pass through the dash panel, and connect the engine room of the vehicle and the indoor heat exchanger 50 with each other. Accordingly, the structure of the refrigerant pipe is simplified.

The refrigerant direction switching portion includes a first direction switching valve 52 and a second direction switching valve 62. The first direction switching valve 52 is provided downstream of the compressor 51 in the refrigerant flow direction to selectively flow the refrigerant to the outdoor heat exchanger 53 or the indoor heat exchanger 50. The second direction switching valve 62 is provided upstream of the indoor heat exchanger 50 in the refrigerant flow direction to send the refrigerant, which has passed through the compressor, to the indoor heat exchanger 50 or to send the refrigerant, which has passed the first expansion valve 55, to the indoor heat exchanger 50.

In addition, a refrigerant branch line 72 which branches off the refrigerant line 71 is provided between the outdoor heat exchanger 53 and the second direction switching valve. The refrigerant branch line 72 allows the refrigerant passing through the outdoor heat exchanger 53 to selectively bypass the indoor heat exchanger 50 and direct to the compressor 51, or allows the refrigerant passing through the indoor heat exchanger 50 to selectively bypass the outdoor heat exchanger 53 and direct to the compressor 51.

The third expansion valve 66 is provided in the refrigerant branch line 72. The third expansion valve 66 is an electric expansion valve (EXV) which expands the refrigerant to the low-temperature and low-pressure state. The third expansion valve 66 is configured to selectively perform a function of expanding the refrigerant or a function of allowing the refrigerant to bypass. Additionally, a chiller 65 is provided in the refrigerant branch line 72. The chiller 65 is a refrigerant-coolant heat exchanger, which heat-exchanges the refrigerant with the coolant circulating through the electrical components or a battery of the vehicle.

Moreover, the fourth expansion valve 54 is provided between the outdoor heat exchanger 53 and the refrigerant branch line 72 to selectively expand the refrigerant. That is, the fourth expansion valve 54 is an electric expansion valve (EXV) to expand the refrigerant to the low-temperature and low-pressure state, and selectively perform a function of expanding the refrigerant or a function of allowing the refrigerant to bypass.

On the other hand, an accumulator 63 which separates gas and liquid from the refrigerant is provided upstream of the compressor 51 in the refrigerant flow direction. Furthermore, a dual pipe 64 is formed in the refrigerant pipe connecting the accumulator 63 and the compressor 51. The dual pipe 64 heat-exchanges the refrigerant of the refrigerant pipe connecting the outdoor heat exchanger 53 and the first expansion valve 55 with the refrigerant of the refrigerant pipe connecting the accumulator 63 and the compressor 51.

The first direction switching valve 52 is a four way valve. The first direction switching valve 52 connects the upstream side of the compressor 51, the downstream side of the compressor 51, the second direction switching valve 62, and the outdoor heat exchanger 53. The first direction switching valve 52 functions as a mode change valve for realizing both cooling and heating with one heat exchanger (indoor heat exchanger).

The second direction switching valve 62 is a four-way valve. The second direction switching valve 62 connects the first indoor heat exchanger 56, the second indoor heat exchanger 57, the first direction switching valve 52, and the first expansion valve 55. The second direction switching valve 62 functions as a valve which allows the refrigerant to first flow into the last column (second column) of the multi-column indoor heat exchanger 50.

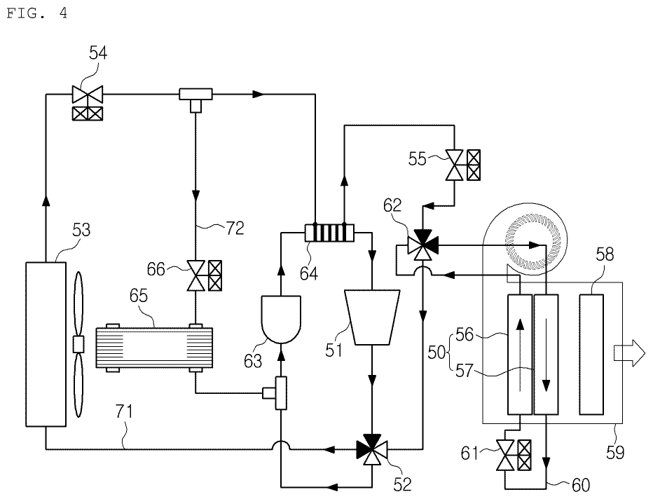

Referring further to FIG. 4, in a cooling mode, the refrigerant discharged from the compressor 51 passes through the first direction switching valve 52 and the outdoor heat exchanger 53, passes through the fourth expansion valve 54, and then expands in the first expansion valve 55. Thereafter, the refrigerant passes through the second direction switching valve 62, passes through the second indoor heat exchanger 57, passes through the second expansion valve 61, passes through the first indoor heat exchanger 56, passes through the second direction switching valve 62 and the first direction switching valve 52, and then, circulates to the compressor 51.

In addition, in the cooling mode, some of the refrigerant passing through the fourth expansion valve 54 flows to the refrigerant branch line 72, expands in the third expansion valve 66, exchanges heat with the coolant while passing through the chiller 65, and then circulates to the compressor 51.

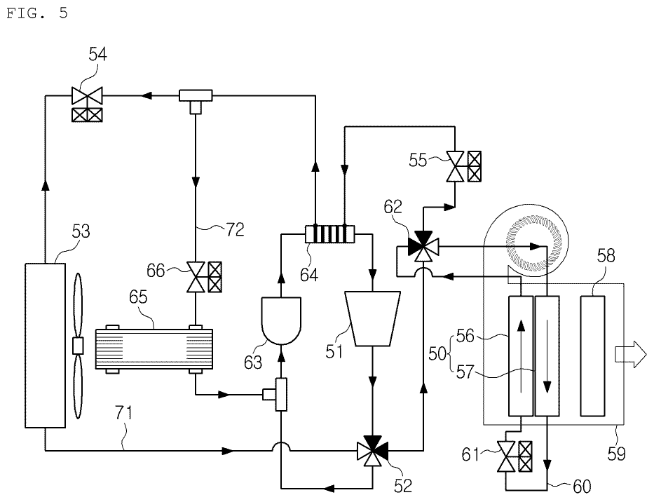

Referring further to FIG. 5, in the heating mode, the refrigerant discharged from the compressor 51 passes through the first direction switching valve 52 and the second direction switching valve 62, passes through the second indoor heat exchanger 57, passes through the second expansion valve 61, and then passes through the first indoor heat exchanger 56. Thereafter, the refrigerant expands in the first expansion valve 55 after passing through the second direction switching valve 62, flows to the refrigerant branch line 72, passes through the third expansion valve 66, passes through the chiller 65, and then circulates to the compressor 51.

In addition, in the heating mode, some of the refrigerant passing through the first expansion valve 55 passes through the fourth expansion valve 54, passes through the outdoor heat exchanger 53 and the first direction switching valve 52, and then circulates to the compressor 51. As described above, when the outdoor temperature is relatively low in the winter, the refrigerant may bypass the outdoor heat exchanger 53 to circulate to the compressor 51.

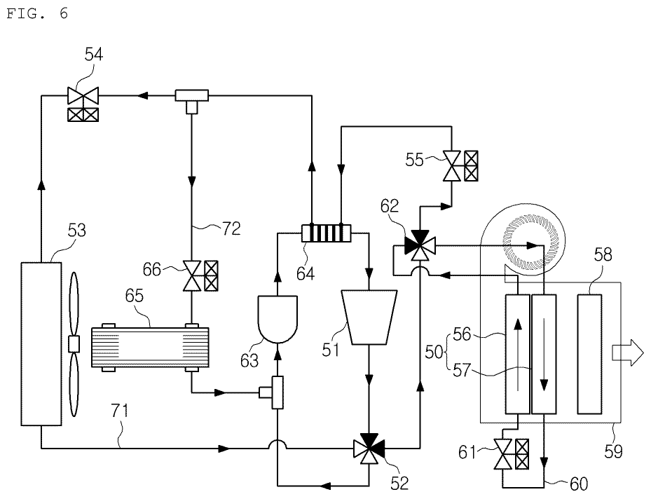

Referring further to FIG. 6, in a dehumidification mode, the refrigerant discharged from the compressor 51 passes through the first direction switching valve 52 and the second direction switching valve 62, expands the second expansion valve 61 after passing through the second indoor heat exchanger 57, and then passes through the first indoor heat exchanger 56. The air in the air-conditioning case 59 is dehumidified by the cold refrigerant passing through the first indoor heat exchanger 56. Thereafter, the refrigerant passes through the second direction switching valve 62, passes through the first expansion valve 55, and then circulates to the compressor after passing through the chiller 65 or the outdoor heat exchanger 53.

As described above, the heat pump system for a vehicle according to an embodiment of the present invention is configured so that the refrigerant always flows to the second indoor heat exchanger 57 earlier than the first indoor heat exchanger 56 in all air-conditioning modes, thereby improving both the cooling performance and the heating performance. Therefore, the heat pump system for a vehicle according to the present invention may improve heat-exchange efficiency by allowing a colder refrigerant in the cooling mode or a hotter refrigerant in the heating mode to pass through the second indoor heat exchanger 57 located downstream in the air flow direction.

Moreover, the heat pump system for a vehicle according to an embodiment of the present invention includes one indoor heat exchanger 50 divided into two parts, thereby realizing all functions of cooling, heating, and dehumidifying with the heat exchanger having the size of the conventional evaporator. Additionally, since it is possible to delete the conventional temperature adjustment door and actuator for adjusting the temperature, the heat pump system for a vehicle according to an embodiment of the present invention can simplify the component configuration and reduce the weight and cost.

Additionally, the heat pump system for a vehicle may include the indoor heat exchanger with first and second columns, wherein the first and second columns can be divided and an EXV type electronic expansion valve is provided between the first and second columns, thus maximizing utilization of the indoor heat exchanger in all air-conditioning-modes such as a cooling mode, a heating mode, a dehumidification mode, and the like.

In addition, since there is only one heat exchanger in which the refrigerant flows in the air-conditioning case by configuring one indoor heat exchanger with first and second columns, the heat pump system for a vehicle requires only two pipes connected to the heat exchanger and the engine room mounted on the air conditioner, thereby simplifying the pipeline.

While the heat pump system for the vehicle of the present invention has been described with reference to the illustrated embodiments, the descriptions are exemplary only, and it will be understood by those skilled in the art that various modifications and equivalents of the embodiments are possible. Therefore, the true technical protection scope should be defined by the technical spirit of the appended claims.

1. A heat pump system for a vehicle, which comprises: a compressor which compresses and discharges a refrigerant; an indoor heat exchanger which is provided in an air-conditioning case and exchanges heat with air discharged into the indoor space of the vehicle; an outdoor heat exchanger which is provided on an outer portion of the air-conditioning case and exchanges heat with external air; and a first expansion valve which expands the refrigerant; controls the flow of the refrigerant discharged from the compressor to perform heating and cooling of the indoor space of the vehicle through the indoor heat exchanger,
wherein the indoor heat exchanger is divided into a plurality of columns on an air passage in the air-conditioning case, and
wherein a refrigerant direction switching portion which controls the flow of the refrigerant is provided such that the refrigerant can first flow into the last column, among the plurality of columns, regardless of air-conditioning modes.

2. The heat pump system according to claim 1, wherein the refrigerant direction switching portion comprises:
a first direction switching valve which is provided downstream of the compressor in a refrigerant flow direction to Selectively flow the refrigerant to the outdoor heat exchanger or the indoor heat exchanger; and
a second direction switching valve which is provided upstream of the indoor heat exchanger in the refrigerant flow direction to send the refrigerant which has passed through the compressor to the indoor heat exchanger or to send the refrigerant which has passed through the first expansion valve to the indoor heat exchanger.

3. The heat pump system according to claim 2, wherein the first direction switching valve and the second direction switching valve are configured as four-way valves.

4. The heat pump system according to claim 1, wherein the indoor heat exchanger is an integrated heat exchanger divided into a plurality of columns.

5. The heat pump system according to claim 2, wherein a second expansion valve which selectively expands the refrigerant is provided in the refrigerant line between the plurality of indoor heat exchangers.

6. The heat pump system according to claim 5, wherein the indoor heat exchanger includes a first indoor heat exchanger and a second indoor heat exchanger sequentially arranged in an air flow direction, and
wherein the first indoor heat exchanger and the second indoor heat exchanger are connected in series on a refrigerant line.

7. The heat pump system according to claim 6, wherein a refrigerant branch line is provided between the outdoor heat exchanger and the second direction switching valve such that the refrigerant passing through the outdoor heat exchanger selectively bypasses the indoor heat exchanger to direct to the compressor or the refrigerant passing through the indoor heat exchanger selectively bypasses the outdoor heat exchanger to direct to the compressor.

8. The heat pump system according to claim 7, wherein in the refrigerant branch line, a third expansion valve for selectively expanding the refrigerant and a chiller for exchanging heat the refrigerant with coolant circulating through electrical components or a battery of the vehicle are provided.

9. The heat pump system according to claim 8, wherein a fourth expansion valve for selectively expanding the refrigerant is provided between the outdoor heat exchanger and the refrigerant branch line.

10. The heat pump system according to claim 6, wherein the first direction switching valve connects the upstream side of the compressor, the downstream side of the compressor, the second direction switching valve, and the outdoor heat exchanger, and
wherein the second direction switching valve connects the first indoor heat exchanger, the second indoor heat exchanger, the first direction switching valve, and the first expansion valve.

11. The heat pump system according to claim 9, wherein in a cooling mode, the refrigerant discharged from the compressor passes through the first direction switching valve and the outdoor heat exchanger, expands in the first expansion valve after passing through the fourth expansion valve, passes through the second direction switching valve, passes through the second indoor heat exchanger, passes through the second expansion valve, passes through the first indoor heat exchanger, passes through the second direction switching valve and the first direction switching valve, and then, circulates to the compressor.

12. The heat pump system according to claim 11, wherein in the cooling mode, some of the refrigerant passing through the fourth expansion valve flows to the refrigerant branch line, expands in the third expansion valve, and then passes through the chiller, circulates to the compressor.

13. The heat pump system according to claim 9, wherein in the heating mode, the refrigerant discharged from the compressor passes through the first direction switching valve and the second direction switching valve, passes through the second indoor heat exchanger, passes through the second expansion valve, passes through the first indoor heat exchanger, expands in the first expansion valve after passing through the second direction switching valve, flows to the refrigerant branch line, passes through the third expansion valve, passes through the chiller, and then circulates to the compressor.

14. The heat pump system according to claim 13, wherein in the heating mode, some of the refrigerant passing through the first expansion valve passes through the fourth expansion valve, passes through the outdoor heat exchanger and the first direction switching valve, and then circulates to the compressor.

15. The heat pump system according to claim 9, wherein in a dehumidification mode, the refrigerant discharged from the compressor passes through the first direction switching valve and the second direction switching valve, expands in the second expansion valve after passing through the second indoor heat exchanger, passes through the first indoor heat exchanger, passes through the second direction switching valve, passes through the first expansion valve, and then circulates to the compressor after passing through the chiller or the outdoor heat exchanger.
